(19) United States
(12) Patent Application Publication
(10) Pub. No.: US 2015/0012988 A1
(43) Pub. Date: Jan. 8, 2015

(54) AUTHENTICATION METHOD AND AUTHENTICATION SYSTEM

(71) Applicant: National Taiwan University of Science and Technology, Taipei (TW)

(72) Inventors: Albert Bor-Ren Jeng, Taipei City (TW); Hahn-Ming Lee, New Taipei City (TW); Te-En Wei, Taipei City (TW); Yuh-Jye Lee, Taipei City (TW)

(21) Appl. No.: 13/935,569

(22) Filed: Jul. 5, 2013

(51) Int. Cl. H04L 29/06

(52) U.S. Cl. CPC H04L 63/0838
USPC 726/7

(57) ABSTRACT

An authentication method and an authentication system are provided. The authentication method includes the following steps. Providing a test image in a first state. Obtaining the test image in a second state in response to a rotating operation. Calculating a difference value between each of image hash values of the test image in the second state and the test image in a third state. Determining that an authentication is successful if the difference value is less than a threshold value, wherein the third state is a state in which the test image is up-right.

### BACKGROUND OF THE INVENTION

1. Field of the Invention

The invention relates to an information security technology, and more particularly, to an authentication method and an authentication system.

2. Description of Related Art

With recent advance in technology, the Internet has become an indispensable source for obtaining information to people nowadays. However, as more and more technologies are developed based on the Internet, information security becomes one of the most significant issues to be discussed, especially when it relates to an identity authentication for a user.

One of the most common identity authentication methods is in the way that the user logins with correct account and password. However, due to Hack technology being developed rapidly, in order to further enhance security of Internet users, a Completely Automated Public Turing Test to Tell Computers and Humans Apart (CAPTCHA) has become one of the most important technologies utilized for identification codes.

A text-based scheme CAPTCHA technology is one of the most popular ways with highest acceptance, which is mainly utilized by performing various processes (e.g., rotation, deformation, distortion, and separation, etc) to a combination of characters and numbers, so that a content that the user may easily identify can be difficult for a robot or an automatic program to identify automatically. However, in order to enhance the security, text being distorted and deformed too much may usually be illegible for the user to identify. Moreover, existing optical character recognition (OCR) software is capable of breaking the text-based scheme CAPTCHA said by using methods such as separating the text and filtering of background noise. An audio-based scheme CAPTCHA technology is mainly utilized by providing an audio content for the user to identify. However, the disadvantage is that, if the audio content is not of a native language to the user, obstacles in identification may then occur. In addition, although a video-based scheme CAPTCHA technology may provide a higher security, the disadvantage is that it may lack of favorable expandability and consume relatively more resources.

Accordingly, besides security matters, a mechanism for identity identification shall also consider more about convenience for the user and feasibility in practical applications.

### SUMMARY OF THE INVENTION

The invention is directed to an authentication method and an authentication system, in which an image is provided for the user to perform rotating operation to make the image in a correct state, and a determination regarding whether the image after the rotating operation matches within an acceptable range is then being made. A personal information can be combined with process of performing the rotating operation, so as to enhance overall information security for avoiding attacks or blocking from a robot or an automatic program.

An authentication method is provided, including: providing a test image in a first state; obtaining the test image in a second state in response to a rotating operation; calculating a difference value between each of image hash values of the test image in the second state and the test image in a third state; and determining that an authentication is successful if the difference value is less than a threshold value, wherein the third state is a state in which the test image is up-right.

An authentication method is provided, including: providing a plurality of test images in a first state; obtaining at least one selected image in a second state from among the test images in response to a selecting sequence and at least one rotating operation corresponding to the selecting sequence; calculating, if the selecting sequence matches a preset sequence, a difference value between each of image hash values of the at least one selected image in the second state and the at least one selected image in a third state, respectively; and determining that an authentication is successful if the difference values are all less than a threshold value, wherein the third state is a state in which the at least one selected image is up-right, and the preset sequence indicates an order of codes for at least one preset image from among the test images.

An authentication system is provided, including an interface unit, an identification image database and a control unit. The identification image database is configured to store a plurality of images. The interface unit is configured to provide a registration interface and an authentication interface. The control unit is coupled to the identification image database and the interface unit, and configured for: providing a test image in a first state; obtaining the test image in a second state in response to a rotating operation; calculating a difference value between each of image hash values of the test image in the second state and the test image in a third state; and determining that an authentication is successful if the difference value is less than a threshold value, wherein the third state is a state in which the test image is up-right.

An authentication system is provided, including an interface unit, an identification image database and a control unit. The identification image database is configured to store a plurality of images. The interface unit is configured to provide a registration interface and an authentication interface. The control unit is coupled to the identification image database and the interface unit, and configured for: providing a plurality of test images in a first state to the authentication interface; obtaining at least one selected image in a second state from among the test images in response to a selecting sequence and at least one rotating operation corresponding to the selecting sequence; calculating, if the selecting sequence matches a preset sequence, a difference value between each of image hash values of the at least one selected image in the second state and the at least one selected image in a third state, respectively; and determining that an authentication is successful if the difference values are all less than a threshold value, wherein the third state is a state in which the at least one selected image is up-right, and the preset sequence indicates an order of codes for at least one preset image from among the test images.

Based on above, the invention provides at least one test image in the authentication interface, so that the user may perform the rotating operation to make the selected image from among the at least one test images in the up-right state. If the process of the rotating operation matches information indicated in the preset sequence received by the user, and the difference value between the two image hash values before and after the rotating operation is less than the threshold value, it is determined that the authentication is successful.

To make the above features and advantages of the disclosure more comprehensible, several embodiments accompanied with drawings are described in detail as follows.

### BRIEF DESCRIPTION OF THE DRAWINGS

FIG. 1 is a block diagram of an authentication system and a user device according to an embodiment of the invention.

FIG. 2 is a schematic diagram of an authentication interface according to an embodiment of the invention.

FIG. 3 is a flow chart of the authentication method according to an embodiment of the invention.

FIG. 4 is a block diagram of an authentication system and a user device according to another embodiment of the invention.

FIG. 5 is a flow chart of the authentication method according to an embodiment of the invention.

FIG. 6 is a schematic diagram of an authentication interface according to an embodiment of the invention.

FIGS. 7A and 7B are schematic diagrams illustrating a personalized rotation sequence information according to an embodiment of the present invention.

FIG. 8 is a flow chart of an authentication process in the authentication method according to an embodiment of the invention.

### DESCRIPTION OF THE EMBODIMENTS

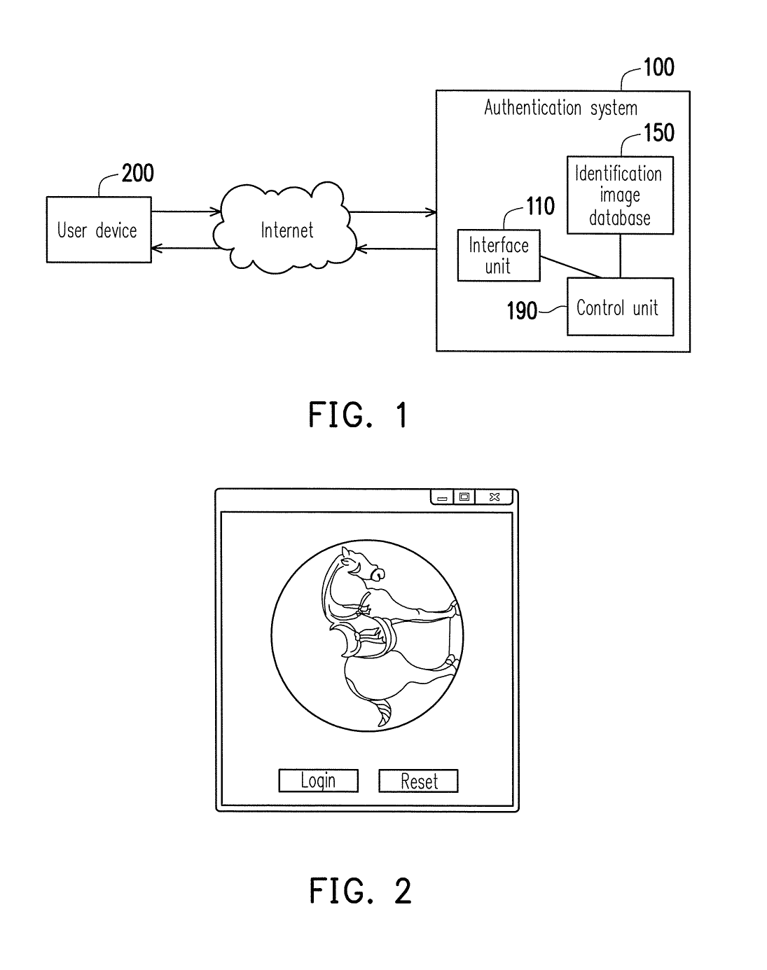

FIG. 1 is a block diagram of an authentication system and a user device according to an embodiment of the invention. As shown in FIG. 1, an authentication system 100 according to the present embodiment of the invention includes an interface unit 110, an identification image database 150 and a control unit 190. The control unit 190 is coupled to the interface unit 110 and the identification image database 150. A user device 200 of a user may communicate to the authentication system 100 via the Internet. In the present embodiment of the invention, the authentication system 100 may be a network server, a personal computer, a workstation, a host computer or various other electronic devices, and the user device 200 may be a notebook computer, a personal digital assistant, a smart phone or other electronic devices capable of surfing the Internet. The interface unit 110 is configured to provide an authentication interface having buttons of login and reset. The identification image database 150 is configured to store a plurality of images, and the control unit 190 is configured to control processes of an authentication. In the present embodiment of the invention, the interface unit 110 and the control unit 190 may be various function modules or microprocessors. The authentication interface may be a web-based interface, a software interface or various other human machine interfaces, and the identification image database 150 may be various storage mediums.

FIG. 2 is a schematic diagram of an authentication interface according to an embodiment of the invention. The following description refers to FIGS. 1 and 2 together.

In the present embodiment of the invention, when the user enters the authentication system 100 for the authentication, a test image is randomly outputted to the authentication interface so that the user may perform an image-based authentication. During an initialization, the test image outputted to the authentication interface may be rotated in advance so as to be represented in a skew state in random angles. The user may easily identify whether the test image in the authentication interface is in the skew state, and perform a rotating operation to rotate said test image in the authentication interface into a up-right state. However, such identification is a difficult task for a robot or an automatic program since whether said image is in the skew state or the up-right state is usually difficult for the robot or the automatic program to identify.

Accordingly, the authentication method according to the invention is capable of effectively preventing attacks from the robot or the automatic program arranged by a hacker. When the test image in the authentication interface is rotated infallibly into the up-right state within an acceptable range by the user, it is then determined that the authentication is successful. In the present embodiment of the invention, the images stored by the identification image database 150 may be filtered out to eliminate inappropriate images therein. Said inappropriate images may be any image that can be easily identified by the robot or the automatic program, or images that cannot be easily identified by the user. In the present embodiment of the invention, the rotating operation performed by the user may be a dragging operation, a button operation or other different input operations to be performed on the authentication interface, but the invention is not limited thereto. The authentication method according the present embodiment of the invention is described in detail as below. All operations related to the user as described below are performed by utilizing the user device 200, thus, the term “user device 200” is omitted and replaced by the term “user” instead as for convenience of the description.

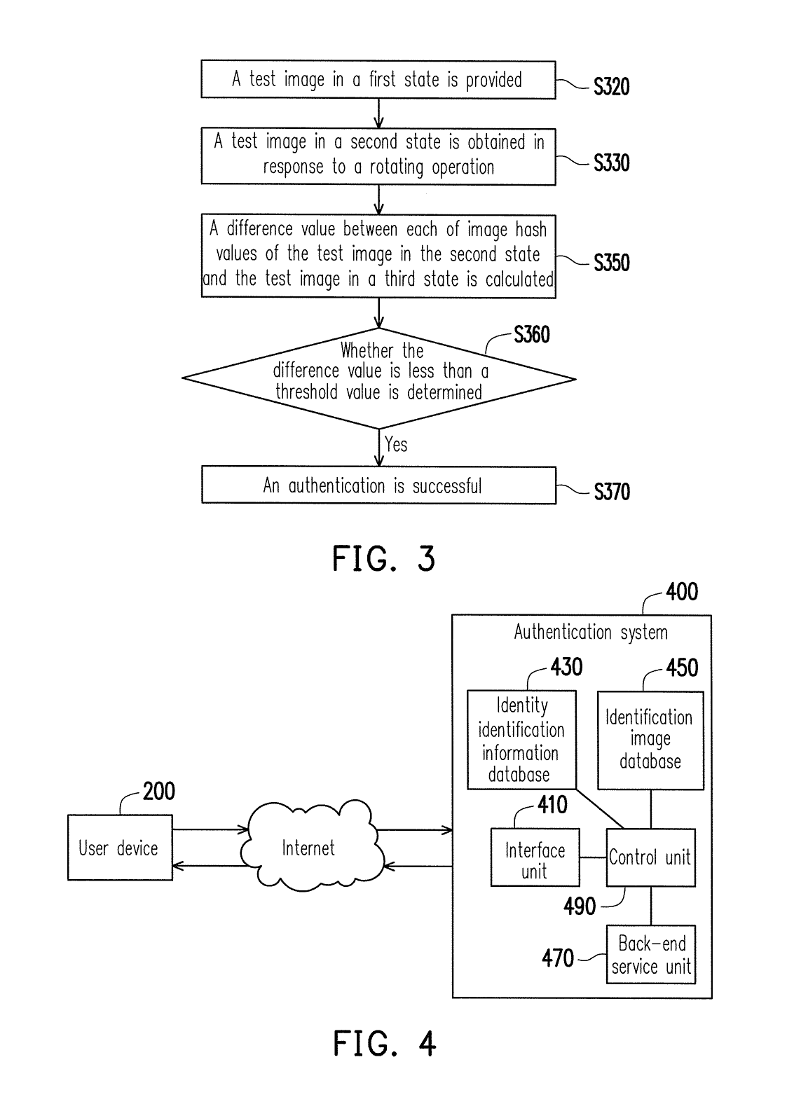

FIG. 3 is a flow chart of the authentication method according to an embodiment of the invention. As shown in FIG. 3, the authentication method according to the present embodiment of the invention includes steps S320, S330, S350, S360 and S370. The following description refers to FIGS. 1, 2 and 3 together.

In step S320, a test image in a first state is provided. For instance, the control unit 190 may randomly rotate the test image in advance, so that the test image outputted to the authentication interface may be represented in the skew state in random angles (i.e., the first state). In the present embodiment of the invention, the test image is a two-dimensional image.

In step S330, the test image in a second state is obtained in response to a rotating operation. For instance, the user may rotate the test image in the skew state in random angles (i.e. the first state) into the up-right state or a state approximates to up-right (i.e., the second state) in the authentication interface by performing the rotating operation (in which errors may occur due to manual operation and visual judgment). Accordingly, the control unit 190 may obtain the test image in the second state.

In step S350, a difference value between each of image hash values of the test image in the second state and the test image in a third state is calculated. In the present embodiment of the invention, the third state is an “absolutely up-right state” predetermined by the authentication system 100 for the test image. Since the user rotates the test image in the skew state (i.e., the first state) into the up-right state or the state approximates to up-right (i.e., the second state) with visual judgment and manual rotating operation, the test image after the rotating operation performed by the user may still include errors with respect to the “absolutely up-right state” (i.e., the third state). In the present embodiment of the invention, the control unit 190 may calculate an image hash value of the test image in the second state, an image hash value of the test image in the third state, and the difference value between said two image hash values by utilizing a hash function, or other software or hardware modules having hash value calculating capabilities.

In step S360, whether the difference value is less than a threshold value is determined. If the difference value is less than the threshold value, it is determined that an authentication is successful in step S370. For instance, if the difference value between the two image hash values before and after the rotating operation is less than the threshold value, it indicates that the test image after the rotating operation is in the up-right state or the state approximates to up-right (i.e., the second state), and offset and error thereof are within the acceptable range with respect to the “absolutely up-right state” (i.e., the third state). Therefore, it can be determined that the authentication is successful. According to the present embodiment of the invention, such determination is based on the image hash values corresponding to the test image, and it is difficult to predict a relation between the test image and the corresponding image hash values. For instance, it is assumed that, after the rotating operation, a difference value of the image hash values respectively calculated from two dissimilar test images is identical, an angle difference of the two dissimilar test images between the second state (the up-right state or the state being approximately up-right) and the third state (the “absolutely up-right state”) may be different. Therefore, in comparison with a determination based on the angle difference corresponding to the test images, the determination of the invention based on the difference value between the image hash values may prevent attacks from the robot or the automatic program more effectively.

FIG. 4 is a block diagram of an authentication system and a user device according to another embodiment of the invention. As shown in FIG. 4, an authentication system 400 of the present embodiment includes an interface unit 410, an identity identification information database 430, an identification image database 450, a back-end service unit 470 and a control unit 490. The control unit 490 is coupled to the interface unit 410, the identity identification information database 430, the identification image database 450 and the back-end service unit 470. A difference between the present embodiment and the foregoing embodiment is described in detail below. The interface unit 410 is configured to provide a registration interface (not illustrated in the drawing) and an authentication interface (as shown in FIG. 2). The identity identification information database 430 is configured to store a preset account and a preset password. The back-end unit 470 is configured to provide a back-end service when it is determined that the authentication is successful. The control unit 490 is configured to control processes of a registration process and an authentication process. In the present embodiment of the invention, the identity identification image database 430 may be various storage mediums. The registration interface and the authentication interface may be a web-based interface, a software interface or various other human machine interfaces, and the back-end service unit 470 may be various functional modules or microprocessors. Details regarding the registration process and the authentication process are as described below. All operations related to the user as described below are performed by utilizing the user device 200, thus, the term “user device 200” is omitted and replaced by the term “user” instead as for convenience of the description.

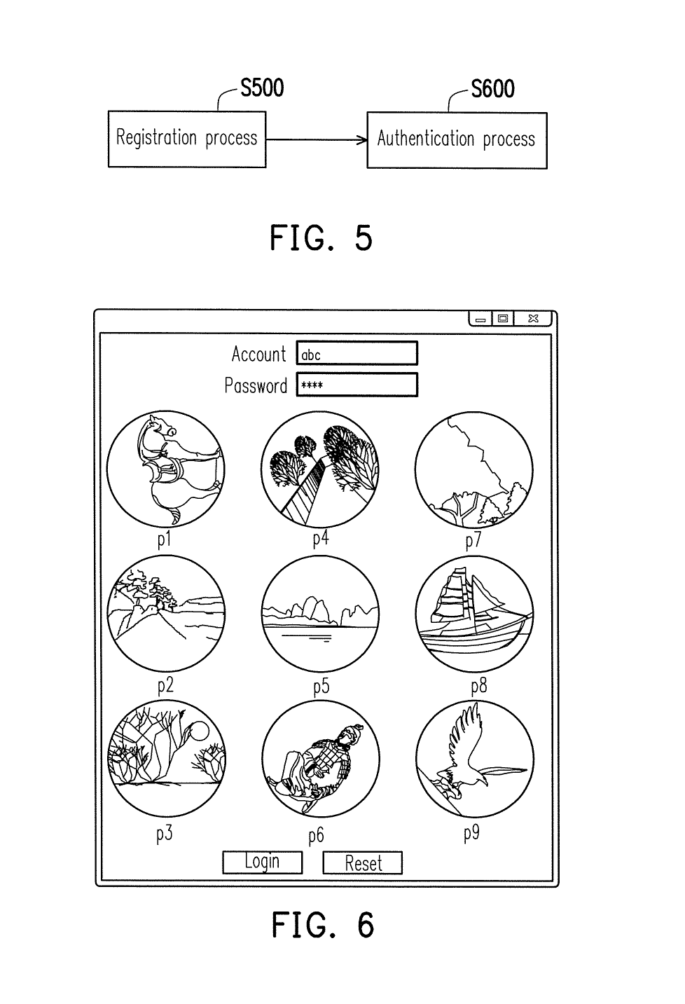

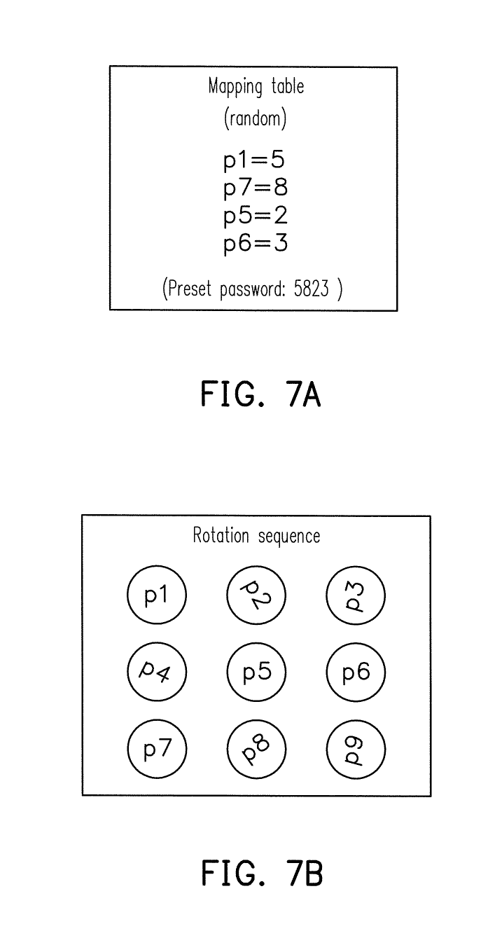

FIG. 5 is a flow chart of the authentication method according to an embodiment of the invention. As shown in FIG. 5, the authentication method according to the present embodiment of the invention includes the registration process (step S500) and the authentication process (step S600). FIG. 6 is a schematic diagram of an authentication interface according to an embodiment of the invention. FIGS. 7A and 7B are schematic diagrams illustrating a personalized rotation sequence information according to an embodiment of the present invention. The following description refers to FIGS. 4, 5, 6, 7A and 7B together.

In the registration process of step S500, the user may store the preset account, the preset password and an email address to the identity identification image database 430 through the registration interface. In another embodiment of the invention, the user may further store a mobile phone number and other contact information to the identity identification image database 430 through the registration interface.

In the authentication process of step S600, it is determined whether a login account and a login password entered by the user through the authentication interface are correct. In addition, a plurality of test images are randomly outputted to the authentication interface for the user to perform an image-based authentication. In the following description, a preset image is an image to be rotated into the up-right state by the user must in order to achieve a successful authentication, and a selected image is an image corresponding to the rotating operation performed by the user in the authentication interface. As shown in FIG. 7A, the user may obtain a mapping table via an email address (or the mobile phone number and other contact information) being registered in advance, and the mapping table indicates a relation between a personalized rotation sequence and at least one preset image from among the test images. In the authentication interface, if the user correctly rotates at least one selected image from among the test images into the up-right state according to the mapping table, and the login account and the login password entered by the user are also correct, it is then determined that the authentication is successful. Subsequently, the back-end serve may be further provided if the authentication is successful. Since the personalized rotation sequence is utilized as an information for the authentication in the present embodiment of the invention, and the rotation sequence corresponding to the authentication interface is obtained by the user from the contact information previous registered, such that attacks as well as blocking of services from the robot and the automatic program may both be avoided. On the other hand, in the present embodiment of the invention, there are multi-factors (such as a contact information authentication, a personalized rotation sequence authentication and the image rotation authentication) utilized in the authentication process, thus the information security may also be further enhanced. The authentication process of step S600 is further described in detail below.

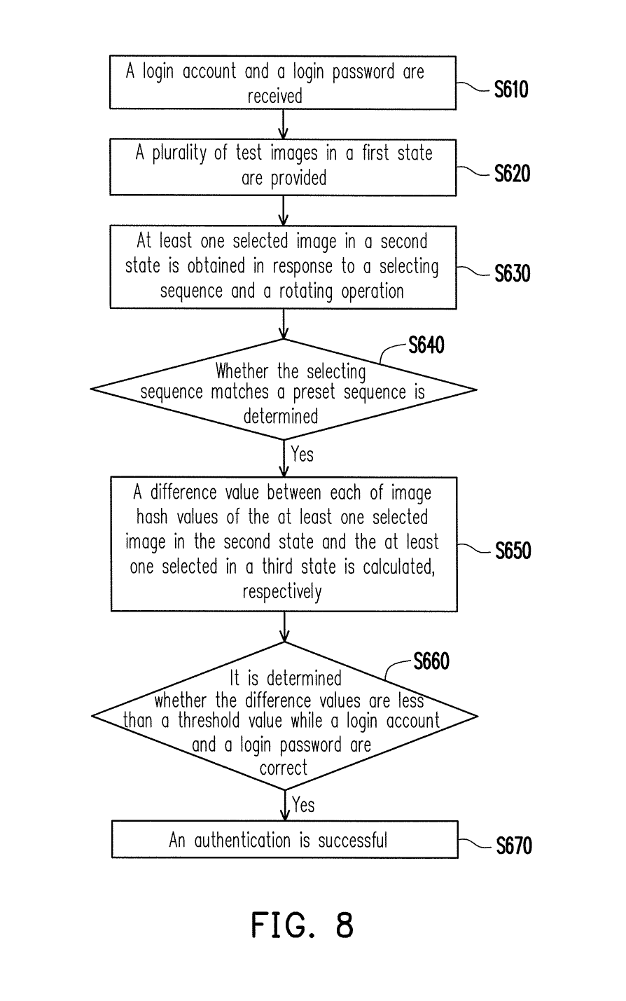

FIG. 8 is a flow chart of an authentication process in the authentication method according to an embodiment of the invention. As shown in FIG. 8, the authentication process according to the present embodiment of the invention includes steps S610 to S670. A difference between the present embodiment and the foregoing embodiment is described in detail below.

In step S610, a login account and a login password are received. For instance, the login account and the login password received through the authentication interface are served as one of conditions for the authentication.

In step S620, a plurality of test images in a first state are provided. What is different from step S320 is that, the control unit 490 may randomly provide and output a plurality of test images to the authentication interface from the identification image database 450 as one of the conditions for the authentication.

In step S630, at least one selected image in a second state from among the test images is obtained in response to a selecting sequence and at least one rotating operation corresponding to the selecting sequence. The selecting sequence is corresponding to an order of the codes for the test images selected by the user. What is different from step S330 is that, the user performs the rotating operation to the at least one selected image from among the test images, respectively, according to a specific selecting order.

In step S640, it is determined whether the selecting sequence matches a preset sequence. What is different from the authentication method of FIG. 3 is that, the user selects the at least one selected image from among the test images such that a determination of whether the selecting sequence matches the preset sequence is further added. The user may obtain the preset sequence from the mapping table. In the present embodiment of the invention, the preset sequence indicates the order of the codes for the at least one preset image among the test images, as shown in FIGS. 7A and 7B. In other words, the preset sequence indicates a relation between the sequence rotation and the preset image. In another embodiment of the invention, as shown in FIG. 7A, the preset sequence may further correspond to the preset password of the user, so that the preset sequence may become a personalized information. In addition, the preset sequence may be an one-time order. In other words, the codes of the preset images as indicated in the preset sequence cannot be re-used. In view of above, the preset sequence corresponding to the preset password (the preset password may also be registered by the user during the registration process) may be obtained by the user via the email address (or the mobile phone number and other contact information) being registered in advance, and served as one of the conditions for the authentication.

In step S650, if the selecting sequence matches the preset sequence, a difference value between each of image hash values of the at least one selected image in the second state and the at least one selected in a third state is calculated, respectively. What is different from step S350 is that, for each of the at least one selected image, the control unit 490 calculates the difference value between the two image hash values before and after the rotating operation.

In step S660, whether the difference values are less than a threshold value is determined. If the difference values are all less than the threshold value, it is determined that the authentication is successful in step S670. Similar to that in steps

S360 and S370, for each of the at least one selected image, if the difference value between the two image hash values before and after the rotating operation is less than the threshold value, it indicates that an error thereof is within an acceptable range, thus it can be determined that the authentication is successful. In the present embodiment of the invention, if it is determined that the authentication is successful, the control unit 490 may provide the user the back-end service through the back-end service unit 470.

In light of above, the invention records information including account, password and contact information of the user, and provides at least one test image in the authentication interface, so that the user may perform the rotating operation to make the selected image from among the at least one test images in the up-right state. If the sequence of performing the rotating operation to the selected image matches the preset sequence indicated in the mapping table which is personalized by the user and obtained through the contact information, while the difference value between the two image hash values of the selected image before and after the rotating operation is less than the threshold value and the account and the password entered in the authentication process are correct, in this case, it is determined that the authentication is successful and then the back service may be provided to the user.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. An authentication method, comprising:
providing a test image in a first state by an control unit;
obtaining a test image in a second state in response to a rotating operation performed by a user device;
providing a test image in a third state, image hash values of the test image in the second state and the test image in the third state by the control unit, and calculating a difference value between the image hash values of the test image in the second state and the test image in the third state by the control unit; and
determining that an authentication is successful by the control unit if the difference value is less than a threshold value.

2. The authentication method of claim 1, further comprising:
receiving a login account and a login password by the control unit.

3. The authentication method of claim 2, wherein the step of determining that the authentication is successful, further comprising:
determining that the authentication is successful by the control unit if the login account and the login password match a preset account and a preset password, respectively.

4. The authentication method of claim 3, wherein before the step of providing the test image in the first state, further comprising:
obtaining the preset account and the preset password through a registration process by the control unit.

5. The authentication method of claim 1, wherein the test image is a two-dimensional image.

6. The authentication method of claim 1, wherein the first state is a random skew state.

7. An authentication method, comprising:
providing a plurality of test images in a first state by an control unit;
obtaining at least one selected image in a second state from among a plurality of test images in response to a selecting sequence and at least one rotating operation performed by a user device corresponding to the selecting sequence;
providing image hash values of the at least one selected image in the second state and at least one selected image in a third state by the control unit if the selecting sequence matches a preset sequence, and calculating a difference value between each of the image hash values of the at least one selected image in the second state and the at least one selected image in the third state by the control unit, respectively; and
determining that an authentication is successful by the control unit if difference values are all less than a threshold value, wherein the preset sequence indicates an order of codes for at least one preset image from among the test images.

8. The authentication method of claim 7, further comprising:
receiving a login account and a login password by the control unit.

9. The authentication method of claim 8, wherein the step of determining that the authentication is successful, further comprising:
determining that the authentication is successful by the control unit if the login account and the login password match a preset account and a preset password, respectively.

10. The authentication method of claim 9, wherein before the step of providing the plurality of test images in the first state, further comprising:
obtaining the preset account, the preset password and an email address by the control unit through a registration process.

11. The authentication method of claim 10, wherein before the step of obtaining the at least one selected image in the second state, further comprising:
sending a mapping table corresponding to the preset sequence by the control unit via the email address to a user who performs the at least one rotating operation,
wherein the mapping table indicates a relation between the preset password and the preset sequence.

12. The authentication method of claim 7, wherein the order of the codes for the at least one preset image is an one-time order.

13. The authentication method of claim 7, wherein the plurality of test images are two-dimensional images.

14. The authentication method of claim 7, wherein the first state is a random skew state.

15. An authentication system, comprising:
an identification image database configured to store a plurality of images;
an interface unit configured to provide a registration interface and an authentication interface; and
a control unit coupled to the identification image database and the interface unit, and configured for:
providing a plurality of test images in a first state to the authentication interface;
obtaining at least one selected image in a second state from among a plurality of test images in response to a selecting sequence and at least one rotating operation performed by a user device corresponding to the selecting sequence;
providing image hash values of the at least one selected image in the second state and at least one selected image in a third state by a control unit if the selecting sequence matches a preset sequence, and calculating a difference value between each of the image hash values of the at least one selected image in the second state and the at least one selected image in the third state by the control unit, respectively; and
determining that an authentication is successful if difference values are all less than a threshold value,
wherein the preset sequence indicates an order of codes for at least one preset image from among the test images.

16. The authentication system of claim 15, further comprising an identity identification information database coupled to the control unit and configured to store a preset account and a preset password, and the control unit is further configured for:
receiving a login account and a login password from the authentication interface; and
determining that the authentication is successful if the login account and the login password match a preset account and a preset password, respectively, and the difference values are all less than a threshold value.

17. The authentication system of claim 16, wherein the control unit is further configured for:
obtaining the preset account, the preset password and an email address through the registration interface; and
sending a mapping table corresponding to the preset sequence via the email address to a user who performs the at least one rotating operation,
wherein the mapping table indicates a relation between the preset password and the preset sequence.

18. The authentication system of claim 15, wherein the order of the codes for the at least one preset image is an one-time order.

19. The authentication system of claim 15, wherein the plurality of test images are two-dimensional images.

20. The authentication system of claim 15, wherein the first state is a random skew state.
